(19) United States
(12) Patent Application Publication
(10) Pub. No.: US 2014/0203005 A1
(43) Pub. Date: Jul. 24, 2014

(54) Welder powered arc starter

(71) Applicant: Gordon R. Hanka, Beaumont, TX (US)

(72) Inventor: Gordon R. Hanka, Beaumont, TX (US)

(21) Appl. No.: 13/747,954

(22) Filed: Jan. 23, 2013

(51) Int. Cl. B23K 9/067

(52) U.S. Cl. CPC B23K 9/067
USPC 219/130.4

(57) ABSTRACT

An electric welding arc starter powered by a switching regulator, which draws its input current from the weld cables. Optionally, the regulator temporarily reduces its input current after the arc igniter fires. Optionally, the regulator temporarily increases its input current before the arc igniter fires.

Patents Referenced

| | | | |
|---|---|---|---|
| 1,615,995 | February 1927 | W. Muller | |
| 2,151,786 | March 1939 | R. E. Marbury | 219/8 |
| 3,440,395 | April 1969 | M. Rebuffoni, et al | 219/131 |
| 5,714,731 | February 1998 | Ulrich, et al | 219/130.4 |

### FIELD OF THE INVENTION

My invention relates to electric arc welding, particularly to devices which help ignite an electric arc.

### BRIEF DESCRIPTION OF DRAWINGS

FIG. 1 depicts a typical arrangement of arc welder and arc starter.

FIG. 2 depicts a boost regulator.

### BACKGROUND OF THE INVENTION

An electric welding arc is harder to ignite than it is to sustain. Consequently, arc welders are commonly augmented with arc starters.

Arc starters come in many forms. Typically they are connected to the weld cables, and augment the weld voltage with periodic high-voltage pulses.

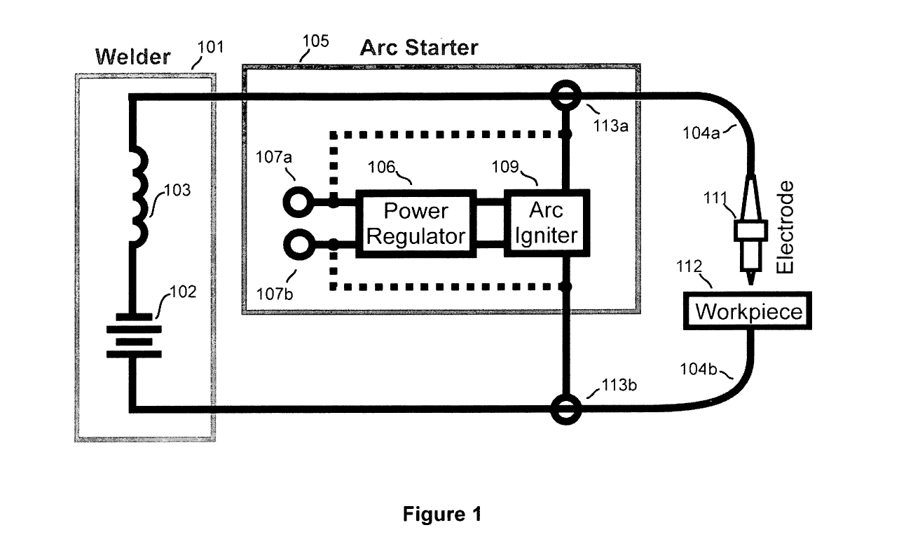

Typically, an arc starter contains a power regulator and an arc igniter, as depicted in FIG. 1. Arc Starter 105 comprises Arc Igniter 109, Power Regulator 106, Input Connectors 107a-b, and Output Connectors 113a-b.

Arc Starter 105 works in conjunction with Welder 101. Welder 101 comprises Power Source 102 and Inductance 103, where Inductance 103 includes the stray inductance of Power Source 102, the inductance of any power inputs to 102 (e.g., the electrical mains) plus any inductive reactors as are commonly added to stabilize a DC welding arc. The output of Welder 101 is transmitted to Electrode 111 and Workpiece 112 by means of Weld Cables 104a-b.

In practice, Arc Starter 105 may be enclosed within Welder 101. However, a stand-alone arc starter has the advantage that it can be used with multiple welders.

In a typical, prior-art arc starter, Input Connectors 107a-b draw power from the electrical mains. Regulator 106 is a passive, step-up transformer. Igniter 109 is a non-resonant Tesla Coil, as described in U.S. Pat. No. 1,615,995. In this embodiment, Output Connector 113a comprises two connectors, one on the welder side, and the other on the torch side.

A disadvantage of the typical, prior-art, stand-alone arc starter is that it requires a connection to the electrical mains. Preferably the arc starter would draw its power from the weld cables. Such a “welder-powered” arc starter would offer the advantages of (1) Fewer wires and connectors; and (2) Usable with simple, battery- or engine-powered welders in remote areas.

To be most useful, a welder-powered arc starter should accommodate a variety of welders. This is problematic because welder output voltage varies widely. A typical welder, intended for handheld use, may output either AC or DC as high as 130 Vpeak or as low as 45 Vrms. (In rare cases, even lower.) Once a welding arc is established, the welder's output voltage may fall below 20 Vpeak.

U.S. Pat. No. 2,151,786 suggests one scheme for a welder-powered arc starter. In this scheme, Regulator 106 is a passive transformer, powered by the weld cables. The transformer is designed such that its output is sufficient to fire Igniter 109 only when its input voltage (the weld voltage) exceeds the typical voltage across an established arc. This scheme has the advantage that the igniter fires only when the arc is extinguished. This scheme has the disadvantage that a passive transformer requires balanced AC input (that is, AC with roughly equal power in the positive and negative polarities) while many welders provide DC or grossly unbalanced AC. A further disadvantage is that a passive transformer must be large and heavy in order to function at the low frequency (typically 60 Hz) provided by AC arc welders.

A disadvantage of a typical, prior-art arc igniter is that its effect dissipates quickly. Experiments reveal that, after a high-voltage spark, arc-path dielectric strength recovers markedly within a few tens of microseconds, which may be too brief for a self-sustaining arc current to rise through Inductance 103. In other words, when the welder has high inductance, it cannot establish a stable arc in the brief window of conductivity created by the arc igniter.

Prior-art arc starters typically address this problem by firing the igniter rapidly and repeatedly. This has the disadvantage of increasing power consumption, heat generation, wear, and electromagnetic interference.

Alternatively, U.S. Pat. No. 3,440,395 suggests shunting (short-circuiting) Inductance 103 at startup, to allow the weld current to build up quickly. However, this scheme cannot mitigate the (often substantial) stray inductance of Power Source 102 and of the electrical mains.

Alternatively, U.S. Pat. No. 5,714,731 suggests establishing a current through Inductor 103 before firing the arc igniter, by means of a shunt that connects Weld Cable 104a to 104b. A disadvantage is that the shunt dissipates power that could be used to power the arc starter. A second disadvantage is that the shunt duplicates a function (current draw) that could be performed by the arc starter's power regulator.

My invention also relates to switching regulators. A switching regulator is a voltage regulator that switches power currents on and off at a frequency higher than the frequency of its input current.

Switching regulators are well known to anyone with ordinary skill in electronics. For example, switching regulators are used by most computers.

Switching regulators compete with other types of voltage regulators, primarily linear regulators and passive transformers. A switching regulator offers several advantages.

Relative to a linear regulator, a switching regulator is more efficient. In many applications, including most arc starters, a linear regulator is not practical because it wastes more power than can be dissipated by a reasonable heat sink.

Relative to a passive transformer, a switching regulator offers the following advantages: (1) Smaller; (2) Does not require balanced AC input; and (3) Maintains a stable output voltage across a range of input voltages.

A switching regulator has three main disadvantages. (1) Expensive switches. (2) Complex control logic. (3) Rapidly varying load on the external power source, which in practice must be smoothed with substantial filters.

A regulator's power capacity depends on its voltage capacity and its current capacity, through the law that power equals voltage multiplied by current. Both voltage capacity, and current capacity affect cost.

It is well known that a “Broad Input” switching regulator can be designed to function across a broad range of input voltages. A device equipped with a broad-input switching regulator could accept a variety of external power sources, though it would still need some external power source. However, a broad-input switching regulator is relatively expensive, because it must tolerate both high peak input voltage and high average input current (though not simultaneously.)

Broad-input switching regulators are not widely used. Typically, a device made to accept multiple input voltages will contain multiple regulators, each optimized for a narrow range of input voltage. For example, a 120-watt device may contain a regulator designed for 12 Vrms at 10 amps from a car battery, and a second regulator designed for 180 Vpeak at 1 amp from electrical mains. Typically, neither regulator would function correctly from an intermediate voltage, say 60 Vrms at 2 amps.

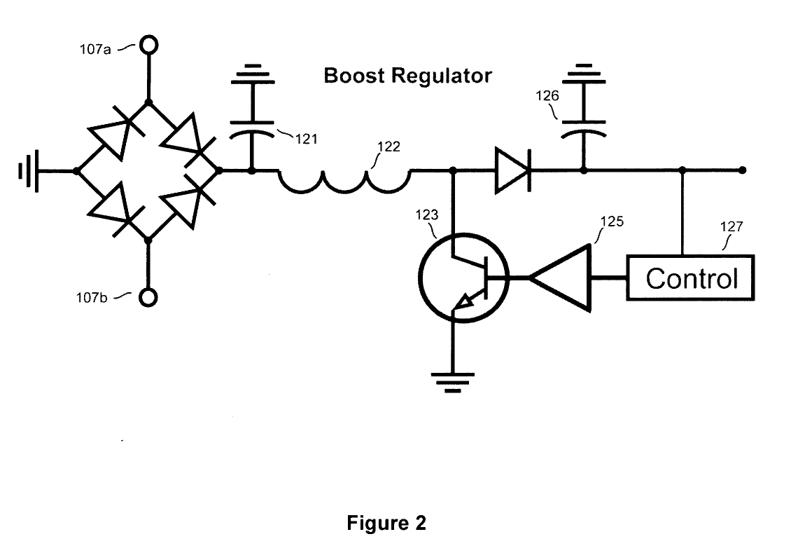

Switching regulators come in many embodiments or “topologies.” The simplest topology is a boost regulator, depicted in FIG. 2.

In FIG. 2, input current arrives through Connectors 107a-b, passes through Inductor 122 and charges Capacitor 126 to the output voltage. Capacitor 121 smooths input current, which reduces electromagnetic noise and allows the current through Inductor 122 to be varied independent of the input current.

To boost the output voltage above the input voltage, Control 127 periodically turns on Switch 123, which draws additional current through Inductor 122. When Switch 123 turns off, the inductive kick forces current into Capacitor 126.

Typically, Control 127 contains a dedicated boost convertor chip, and/or a general-purpose processor, and circuitry to sense external voltages.

Typically, Control 127 senses the output voltage across Capacitor 126, through a resistive divider. Control 127 then adjusts the duty cycle of Switch 123 in order to equate the divided-down output voltage to a reference voltage. In the prior art, various algorithms are used for adjusting the duty cycle. Such algorithms are well known to anyone with ordinary skill in power supply design, and all tend to increase Switch 123's duty cycle when the output voltage falls below its target. Consequently, a prior-art switching regulator will tend to increase input current immediately after Igniter 109 fires, because firing the igniter will partially deplete Capacitor 126.

Typically, Switch 123 comprises one or more transistors, whose gate(s) are driven by Driver 125, where Driver 125 is typically a mosfet driver, a common device familiar to anyone with ordinary skill in electronics.

Switch 123's current capacity is determined primarily by the size of its heat sink and by its on-state resistance. (Or, for a bipolar transistor, its on-state voltage drop.)

Since Switch 123 is a transistor, its breakdown voltage depends on details of its internal construction, as is known to anyone with ordinary skill in transistor design. In practice, a transistor's breakdown voltage is inversely related to its current capacity. That is, for a given cost and size, increasing the breakdown voltage of Switch 123 will tend to reduce its current capacity. This tradeoff increases the cost of a broad-input switching regulator, which must tolerate both high peak voltage and high average current (though not at the same time.)

In the boost topology, the maximum voltage across Switch 123 is approximately equal to the output voltage, but this is not true of other topologies.

Switch 123's switching frequency is also important. The switching frequency must be high enough to limit maximum current to the capacity of Inductor 122 and Switch 123. However, lower frequencies are desirable because each switch turn-on and turn-off wastes power, and generates heat that must be dissipated. The required switching frequency can be reduced by increasing the inductance of 122, or by increasing the current capacity of both Inductor 122 and Switch 123.

In practice, the cost and capacity of Inductor 122 are determined by its physical size. For a given size, the product of 122's inductance and current capacity will be roughly constant. Higher current capacity is required for lower input voltage, but higher inductance is preferable for higher input voltage, to reduce the required switching frequency. Demanding both high inductance and high current capacity, as required by a broad-input switching regulator, requires a larger, more expensive inductor.

Alternatively, some prior-art topologies accommodate varying input voltages by means of a multi-tap transformer. This has the disadvantage of requiring multiple switches.

### BRIEF DESCRIPTION OF THE INVENTION

My invention is to power an arc starter from the weld cables, by means of a broad-input switching regulator with input power connectors suitable for attachment to weld cables. My invention is further to vary the arc starter's input current to assist arc ignition, by temporarily increasing input current before firing the igniter, and/or temporarily reducing input current after firing the arc igniter.

### DETAILED DESCRIPTION

In my invention, Regulator 106 draws its input power from connectors suitable for attachment to weld cables. In the preferred embodiment, Input Connector 107a-b are omitted, and Regulator 106 draws its input power from Connectors 113a-b, the same connectors that deliver Igniter 109's output to the weld cables and/or are used to monitor the weld voltage. This has the advantage of minimizing the number of connectors.

Many types of input connector are suitable for attachment to weld cables, but in the preferred embodiment, the input connectors will be “Quick change” DINSE-type connectors, or in the alternative, brass threaded lugs of size ¼″ to ½″. These connectors have the advantage of widespread use, and are familiar to anyone with ordinary skill in welding.

My invention exploits a broad-input switching regulator, defined as a switching regulator that functions with a wider range of input voltages than would be expected from electrical mains or from batteries.

In my invention, a broad-input switching regulator offers two novel and unexpected benefits.

First, in my invention a broad-input switching regulator offers the novel and unexpected benefit of eliminating external power sources, because all input power can be drawn from Igniter 109's pre-existing connection to the weld cables.

Second, my invention offers the novel and unexpected benefit of exploiting two disadvantages of a switching regulator, its complex control logic and its uneven current demand, and turning them into advantages. By modifying Control 127, the switching regulator's input current can be varied to assist arc ignition.

In the preferred embodiment, Regulator 106 will temporarily increase its input current before Igniter 109 fires, in order to establish a current through Inductance 103. The precise amplitude and duration of the increase is not critical, but common welders can require on the order of a millisecond to build up weld current. Good results will be obtained by drawing increased input current for two milliseconds, reaching a maximum of five amps.

In my invention, Regulator 106 reduces its input current after Igniter 109 fires, to avoid drawing current away from the newly established arc. This timing scheme represents the opposite of the prior art, because a prior-art regulator would draw maximum input current just after Igniter 109 fires, to replenish the power that the igniter drew from Capacitor 126.

In the preferred embodiment, Regulator 106 reduces its input current to zero after Igniter 109 fires. The precise duration of reduced input current is not critical, but should be at least one millisecond to ensure establishment of a stable arc current. In the preferred embodiment, Regulator 106 will draw no input current until two milliseconds before the next firing of Igniter 109, in order to maximize the pre-firing current through Inductor 103. This timing scheme will increase the current capacity required of Regulator 106, and the required size of Capacitor 126, relative to a prior-art arc starter which can draw input current continuously.

When Regulator 106 reduces its input current, Inductance 103 will create an inductive kick that briefly boosts the weld voltage across Cables 104a-b. The details of this inductive kick will depend on the size of Inductance 103 and Capacitor 121, in relations well known to anyone with ordinary skill in electronics. The inductive kick can assist with arc ignition, especially if timed to coincide with the firing of Igniter 109.

The timing of the inductive kick will vary across welders. Optionally, Control 127 can monitor the voltage across Weld Cables 104a-b, and adjust the timing of Regulator 106's current draw, and/or Igniter 109's firing, so that the inductive kick generates maximum weld voltage when Igniter 109 fires. In the preferred embodiment, weld voltage will not be kicked above 130V, to comply with safety standards for handheld welders.

Alternatively, Regulator 106's current draw can be timed so that the inductive kick generates maximum weld voltage before the planned firing of Igniter 109, in the hopes that the inductive kick will ignite the arc, so that Igniter 109 need not be fired.

In the preferred embodiment, Control 127 includes a general-purpose microcontroller that controls both Switch 123 and Igniter 109, and senses external voltages through resistive networks connected to analog-to-digital converters. Such devices are well known to anyone with ordinary skill in electronic design. In this embodiment, adjusting the timing of Regulator 106's input current, and/or the timing of Igniter 109's firing, will require only software modification to Control 127, obvious to anyone with ordinary skill in programming.

“Firing” Igniter 109 may involve multiple events spread over time. For example, good results are obtained from a series of five high-voltage sparks at intervals of 150 microseconds.

In the preferred embodiment, Regulator 106 will operate safely from any input voltage between 20 Vpeak and 130 Vpeak, the voltages typically encountered across weld cables. This design constraint is readily satisfied by means obvious to anyone with ordinary skill in power supply design.

In the preferred embodiment, the voltage across an established welding arc will be sufficient to operate the arc starter in standby mode. Specifically, when input voltage falls to 20 Vpeak (a voltage typical of an established arc) Regulator 106 will still supply enough power to operate auxiliary systems such as cooling fans and user interface. This design constraint is readily satisfied by means obvious to anyone with ordinary skill in power supply design.

In the preferred embodiment, the voltage across an extinguished welding arc will be sufficient to power Igniter 109. Most welders will drive an extinguished arc with voltage in the range 45 Vrms-130 Vpeak. Thus, in the preferred embodiment, Regulator 106 will have sufficient capacity to operate Igniter 109, and any auxiliary systems such as cooling fans and user interface, from input voltage as low as 45 Vrms or as high as 130 Vpeak. This design constraint is readily satisfied by means obvious to anyone with ordinary skill in power supply design.

In the preferred embodiment, Inductor 122 must withstand the high input currents required for input voltages substantially below those of the electrical mains. Consequently, Inductor 122 must be physically larger than would be required by a prior-art, mains-powered arc starter.

In the preferred embodiment, Switch 123 must withstand the high input currents required for input voltages substantially below the electrical mains. Consequently, Switch 123 must have a larger heat sink, and/or lower on-state resistance than would be needed for a prior-art, mains-powered arc starter.

In the preferred embodiment, Regulator 106 and Control 127 comprise a boost regulator, as depicted in FIG. 2. Alternative switching topologies are acceptable, but the boost topology is simplest, and it delivers a high voltage convenient for common arc igniters. In practice, additional regulators may be required to supply Control 127 and auxiliary systems such as cooling fans and user interface.

Not shown in the figures are various auxiliary systems, such as cooling fans, user interface, and additional power regulators, as will be obvious to anyone with ordinary skill in electronic design.

I claim:

1. An arc starter, comprising an arc igniter, a switching regulator, and input connectors; said arc igniter is powered by said switching regulator; said switching regulator draws input current through said input connectors; said input connectors are suitable for attachment to weld cables.

2. An arc starter as defined in claim 1, wherein said regulator draws less input current in the 100 microseconds after firing said arc igniter, relative to the 100 microseconds before said firing.

3. An arc starter as defined in claim 1, wherein said regulator creates a temporary increase in said input current, and further wherein said temporary increase substantially ends not more than one millisecond prior to firing said arc igniter, and further wherein said temporary increase substantially ends prior to 100 microseconds after firing said arc igniter.

4. An arc starter as defined in claim 1, wherein said regulator is capable of powering said arc igniter from input voltage lower than 60 Vrms, and further wherein said regulator is capable of powering said arc igniter from input voltage greater than 120 Vpeak.

5. An arc starter as defined in claim 4, wherein said regulator draws less input current in the 100 microseconds after firing said arc igniter, relative to the 100 microseconds before said firing.

6. An arc starter as defined in claim 4, wherein said regulator creates a temporary increase in said input current, and further wherein said temporary increase substantially ends not more than one millisecond prior to firing said arc igniter, and further wherein said temporary increase substantially ends prior to 100 microseconds after firing said arc igniter.
